(19) United States
(12) Patent Application Publication
(10) Pub. No.: US 2008/0057987 A1
(43) Pub. Date: Mar. 6, 2008

(54) LOCATION MESSAGE COORDINATOR, METHOD OF COORDINATING A LOCATION MESSAGE AND A CELLULAR SYSTEM EMPLOYING THE SAME

(75) Inventors: Assaf Landschaft, Munich (DE); Laurent Mauguee, Munchen (DE)

Correspondence Address: HITT GAINES, PC;LSI Corporation, PO BOX 832570, RICHARDSON, TX, 75083, US

(73) Assignee: Agere Systems Inc., Allentown, PA (US)

(21) Appl. No.: 11/470,481

(22) Filed: Sep. 6, 2006

(51) Int. Cl. H04Q 7/20

(52) U.S. Cl. 455/466

(57) ABSTRACT

The present invention provides a location message coordinator for use with a short message service (SMS). In one embodiment, the location message coordinator includes a sender location unit configured to determine a location of a mobile communication device. Additionally, the location message coordinator also includes a message sending unit coupled to the sender location unit and configured to automatically send a predefined SMS message based on the location of the mobile communication device.

### TECHNICAL FIELD OF THE INVENTION

The present invention is directed, in general, to communication systems and, more specifically, to a location message coordinator, a method of coordinating location messages and a cellular system employing the coordinator or the method.

### BACKGROUND OF THE INVENTION

Currently, mobile communication devices, including mobile phones, have become portable information exchange systems and entertainment centers having features that were only imagined a short time ago. For example, currently available mobile phones allow viewing of news, weather, sports and entertainment video updates and play cutting edge three-dimensional games. Features such as video on demand and audio on demand allow playing of video and audio clips. Movie and music fans can download content on their mobile phones, with just a few clicks, having sharpness and clarity. Video messaging and still pictures may be recorded and sent to any e-mail address. Many of these features require substantial airtime or additional charges that are not insignificant.

Short message service (SMS) is a mechanism of delivery of short messages over the mobile networks. It is a store and forward way of sending messages to and from mobile phones. Each short message can include up to 160 characters that can be alphanumeric (text) or binary non-text short messages. SMS has gained rapid popularity because it provides a permanent message, like e-mail, at a fraction of the cost of voice or video messaging and can be sent and received essentially without the interruption that is usually associated with voice communication.

Generally, a mobile phone user writes an SMS message and sends the SMS message to a corresponding addressee. The corresponding addressee often responds and an interchange of SMS messages may ensue. Writing an SMS message usually requires that the mobile phone user is stationary or is at least not engaged in a mobile activity that requires concentration such as driving an automobile or riding a bicycle or motorcycle. A requirement to send SMS messages under these conditions usually requires stopping.

Accordingly, what is needed in the art is a way to provide an SMS message while engaged in an activity that produces an impedance or distraction to SMS messaging.

### SUMMARY OF THE INVENTION

To address the above-discussed deficiencies of the prior art, the present invention provides a location message coordinator for use with a short message service (SMS). In one embodiment, the location message coordinator includes a sender location unit configured to determine a location of a mobile communication device. Additionally, the location message coordinator also includes a message sending unit coupled to the sender location unit and configured to automatically send a predefined SMS message based on the location of the mobile communication device.

In another aspect, the present invention provides a method of coordinating a location message, for use with a short message service (SMS). The method includes determining a location of a mobile communication device and automatically sending a predefined SMS message based on the location of the mobile communication device.

The present invention also provides, in yet another aspect, a cellular system. The cellular system includes a communications network employing a cellular grid and provides a short message service (SMS). The cellular system also includes a mobile communication device coupled to the cellular grid and a location message coordinator coupled to the mobile communication device. The location message coordinator has a sender location unit that determines a location of the mobile communication device, and a message assigning unit, coupled to the sender location unit, that assigns a predefined SMS message to a contact addressee. The location message coordinator also has a message sending unit, coupled to the message assigning unit, that automatically sends the predefined SMS message to the contact addressee based on the location of the mobile communication device.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a cellular system constructed in accordance with the principles of the present invention; and

FIG. 2 illustrates a flow diagram of an embodiment of a method of coordinating a location message carried out in accordance with the principles of the present invention.

### DETAILED DESCRIPTION

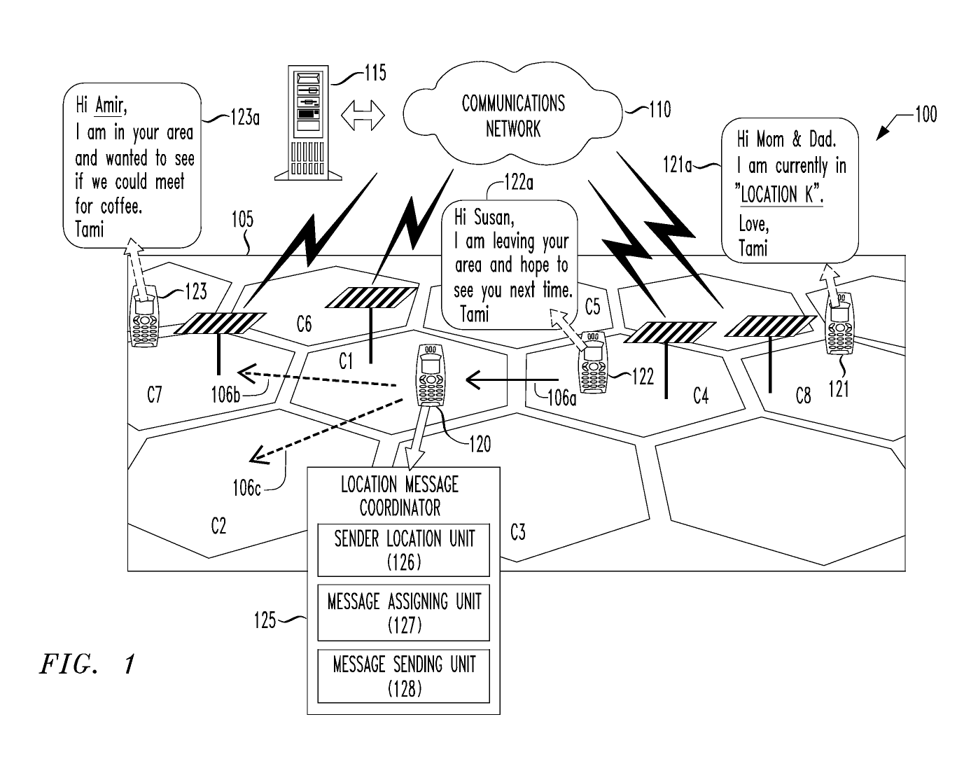

Referring initially to FIG. 1, illustrated is a system diagram of an embodiment of a cellular system, generally designated 100, constructed in accordance with the principles of the present invention. The cellular system 100 provides a short message service (SMS) and includes a cellular grid 105 having a plurality of cells C1-C8 that are coupled to a communications network 110 and a network server 115. The cellular system 100 also includes a plurality of mobile communication devices, which are mobile phones in the illustrated embodiment that employ the SMS for short message transmissions. A first mobile phone 120 is initially located in a serving cell C1, and second, third and fourth mobile phones 121, 122, 123 are located in serving cells C8, C4 and C7, respectively.

In one embodiment of the present invention, the cellular system 100 is a Global System for Mobile Communications/Universal Mobile Telecommunications System (GSM/UMTS). Each of the plurality of cells C1-C8 employs a GSM mast (transmission antenna) wherein only those employed in the serving cells C1, C4, C7 and C8 are shown, as exemplary. Each of the GSM masts is associated with a Cell-ID. Gathering of these Cell-IDs along with their accompanying geographical locations into a Cell-ID database allows identification of a current approximate physical location for a mobile phone employing the GSM mast.

In the cellular system 100, a Cell-ID database may be maintained in the network server 115. This Cell-ID database may be queried by a sending mobile phone to determine its approximate location. Alternatively, the sending mobile phone may employ a local database that is located within the sending mobile phone. This local database may be provided through routine software upgrades or be downloaded from the network server 115.

Additionally, the Cell-ID database may be either a public database that is available on the Internet (for example, http://janus.liebregts.nl/cellid/NL/) or a private database. Network operators may provide their own databases and are able to offer them as a service for their users. These databases can be downloaded to the sending mobile phone and used locally, as discussed above. Alternatively, these databases may be accessed online employing the Internet.

In the illustrated embodiment of FIG. 1, the first mobile phone 120 is employed by a user that is traveling across the cellular grid 105. The first mobile phone 120 includes a location message coordinator 125 coupled to the first mobile phone 120. The location message coordinator 125 includes a sender location unit 126, a message assigning unit 127 and a message sending unit 128. The sender location unit 126 determines a location of the first mobile phone 120, and the message assigning unit 127, which is coupled to the sender location unit 126, assigns a predefined SMS message to a contact addressee. The message sending unit 128 is coupled to the message assigning unit 127 and automatically sends the predefined SMS message to the contact addressee based on the location of first mobile phone 120.

In the illustrated embodiment, the location of the first mobile phone 120 is based on the Cell-ID associated with the serving cell C1. The first mobile phone 120 may employ the sender location unit 126 to detect its location intermittently or track it continuously. Additionally, a look-up table is employed to map the Cell-ID into a geographic region that corresponds to at least an approximate physical location of the first mobile phone 120. If the first mobile phone 120 is employing a well-defined travel path through the cellular grid 105 and traveling at a somewhat constant speed, the sender location unit 126 may employ the changing Cell-IDs to interpolate locations within a serving cell thereby providing a more definitive estimate of physical location.

In one embodiment, generation of a predefined SMS message is performed by the user of the first mobile phone 120. Alternatively, generation of the predefined SMS message may be performed by a provider of the first mobile phone 120, as an “add-on” to the mobile phone, by a communication network provider or an Internet service provider (ISP). These predefined SMS messages may typically be stored in a database in the first mobile phone 120. Alternatively, they may also be stored and provided employing a network database, wherein the network server 115 is representative.

The predefined SMS messages may contain “fill-in-the-blanks” thereby making a portion of it amendable. These portions of the predefined SMS messages may be completed manually by the user of the first mobile phone 120. Alternatively, these portions may be supplied automatically by either the first mobile phone 120 or an external unit such as the network server 115 based on knowing the position of the first mobile phone 120 in the cellular grid 105.

In one embodiment, detection of a change in the serving cell causes the first mobile phone 120 to insert its current sending location into those predefined SMS messages that require an addition of the sending location before the message is sent. In an alternative embodiment, a sending location for the mobile phone 120 is part of the predefined SMS message, and it is automatically sent when the location of the first mobile phone 120 matches this sending location.

Additionally, a set of predefined SMS messages may be employed that have a same or similar message but provide a corresponding set of predefined sending locations along a predetermined travel path. Then a portion or all of this set of predefined SMS messages may be employed along the travel path, as may be determined by the sending user of the first mobile phone 120, for example.

In the illustrated embodiment, a contact addressee usually corresponds to a user of a receiving mobile phone or other appropriate mobile communication device. Contact addressee groups may include individuals, businesses and organizations, including hotels and restaurants, as well as governmental or educational entities. Selection of contact addressees may be based on either an addressee group or a contact location.

The message assigning unit 127 may assign a predefined SMS message to a contact addressee employing either a manual assignment process or an automated assignment process. In the manual assignment process, the sending user of the first mobile phone 120 selects and assigns at least one predefined SMS message to the contact addressee some time before the message is to be sent. In the automated assignment process, the travel path indicated by the sending user of the first mobile phone 120 may be employed to link appropriate predefined SMS messages to contact addressees corresponding to contact locations along the travel path.

In one embodiment, automatically sending a predefined SMS message or plurality of predefined SMS messages by the message sending unit 128 occurs when the first mobile phone 120 changes serving cells in the cellular grid 105. This allows the first mobile phone 120 to operate in a “physical-location automatic update (PLAU)” mode. In the PLAU mode, as the first mobile phone 120 enters the serving cell C1 it automatically sends a predefined SMS message 121a to the second mobile phone 121, as shown in FIG. 1.

This predefined SMS message 121a indicates that the sending user (i.e., Tami) has just entered the serving cell C1 representative of a new location (i.e., LOCATION K), which automatically provides Mom and Dad with progress along Tami's travel path 106a. This predefined SMS message 121a would continue to be sent automatically as each new serving cell is entered with appropriate updates provided to LOCATION K.

In another embodiment, automatically sending a predefined SMS message or plurality of predefined SMS messages when the first mobile phone 120 has either entered or left a predetermined location allows operating in an “automatic messaging group (AMG)” mode that is based on a physical location. This is somewhat analogous to instant messaging on the WWW. This mode makes selected contact addressees within a geographic area aware that a sending user has either entered or left their area of predetermined location.

This predetermined location may correspond to a particular serving cell associated with a contact addressee or plurality of contact addressees. For example, the third mobile phone 122 corresponds to a contact addressee in the serving cell C4 that the first mobile phone 120 has just left. A predefined SMS message 122a indicates to the receiving user (i.e., Susan) of the third mobile phone 122 that the sending user Tami has left Susan's area. This message may correspond to a previous correspondence sent to Susan indicating the possibility of meeting.

This predetermined location may also correspond to a geographic region containing cells adjacent to a particular serving cell. For example, the cells C1, C2 and C6 correspond to a geographic region adjacent to the cell C7. As the first mobile phone 120 moves into the serving cell C1, a predefined SMS message 123a is automatically sent to the fourth mobile phone 123 intended for a receiving user Amir, whose name has been amended dither manually or automatically to the predefined SMS message 123a. A sending user option exists to resend the predefined SMS message 123a when the first mobile phone 120 enters either the cell C7 or C2 depending on the respective travel path 106b or 106c that is chosen.

Although a majority of predefined SMS messages may be sent only once based on the location of the first mobile phone 120, some of the predefined SMS messages may be sent more often. For example, if the first mobile phone 120 remains within a serving cell for a predetermined period of time, which may be settable or adjustable by the sending user, a predefined SMS message may be sent periodically to indicate this condition. Of course, the sending user of the first mobile phone 120 may amend or supplement the information in this predefined SMS message to indicate a reason for having slowed down or an actual location for having stopped.

In the illustrated embodiment, the location message coordinator 125 is a software implementation that may be built on existing hardware thereby allowing efficient use of an installed equipment base by adding both utility and value. In an alternative embodiment, it may be a hybrid combination of software and hardware or produced completely in a hardware implementation.

In alternative embodiments, at least a portion of the mobile communication devices may be devices other than a mobile phone, such as a laptop computer or PDA, assuming that they are capable of discerning their location and communicating employing the SMS.

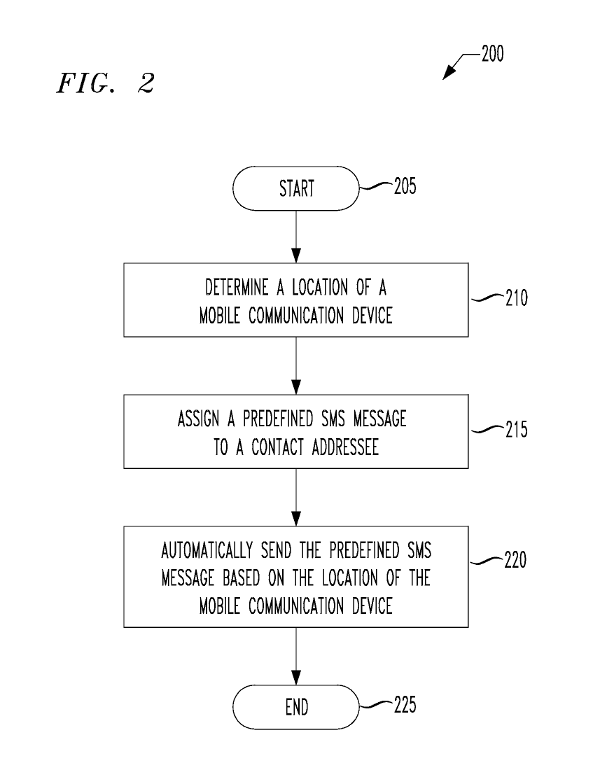

Turning now to FIG. 2, illustrated is a flow diagram of an embodiment of a method of coordinating a location message, generally designated 200, carried out in accordance with the principles of the present invention. The method 200 is for use with a short message service (SMS) and starts in a step 205. Then, a location of a mobile communication device is determined in a step 210. In one embodiment, the location is based on a Cell-ID in a cellular system that contains the mobile communication device. Additionally, the location is determined by a look-up table that maps the Cell-ID into a geographic region.

A predefined SMS message is assigned to a contact addressee in a step 215. In one embodiment, the predefined SMS message is a text message wherein a portion of the predefined SMS message is amendable. That is, a name associated with the contact addressee or the location associated with the mobile communication device may be inserted at designated positions within the predefined SMS message. Additionally, the contact addressee may be selected based on a contact location or an addressee group. The contact location is typically one that is along a travel path of a user of the mobile communication device. The addressee group is often one involving family or friends. Alternatively, it could be one involving business associates or other organizational entities.

In one embodiment, the predefined SMS message is provided by a network database. Alternatively, the predefined SMS message may be provided from a database that resides in the mobile communication device. The assignment of the predefined SMS message to the contact addressee in the step 215 may be accomplished employing a manual assignment process wherein the user of the mobile communication device makes the assignment at some time prior to its use. Alternatively, the assignment may be an automated assignment process wherein it is occurs when the mobile communication device has reached a certain location.

Then, in a step 220, the predefined SMS message is automatically sent based on the location of the mobile communication device. In one embodiment, automatically sending the predefined SMS message corresponds to the location of the mobile communication device changing from one serving cell to another serving cell of the cellular system. In one case, contact addressees associated with a location in a previous serving cell of the cellular network may be informed that the user has left their geographic region. In another case, contact addressees associated with a current cell may be informed that the user is now in their geographic location.

In an alternative embodiment, automatically sending the predefined SMS message corresponds to the location of the mobile communication device remaining in the same serving cell of the cellular system for a predetermined period of time. This predetermined period of time may be set by the user or is selected by the mobile communication device. This allows an intended contact addressee to receive periodic updates that indicate the user has either slowed down or stopped. The method 200 ends in a step 225.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a location message coordinator, a method of coordinating a location message and a cellular system employing the coordinator or the method have been presented. Advantages include the ability to allow the user of a mobile communication device to provide a physical-location automatic update mode, which allows automatic tracking of the location of a user of a mobile communication device, such as a cell phone. Additionally, an automatic messaging group mode may be employed wherein the user provides predefined SMS messages to contact addressees based on being in a geographic location associated with the contact addressees.

Although the present invention has been described in detail, those skilled in the art should understand that they can make various changes, substitutions and alterations herein without departing from the spirit and scope of the invention in its broadest form.

What is claimed is:

1. A location message coordinator for use with a short message service (SMS), comprising:
a sender location unit configured to determine a location of a mobile communication device; and
a message sending unit coupled to said sender location unit and configured to automatically send a predefined SMS message based on said location of said mobile communication device.

2. The coordinator as recited in claim 1 wherein said location is based on a Cell-ID in a cellular system.

3. The coordinator as recited in claim 2 wherein said location is determined by a look-up table that maps said Cell-ID into a geographic region.

4. The coordinator as recited in claim 1 wherein a portion of said predefined SMS message is amendable.

5. The coordinator as recited in claim 1 wherein said predefined SMS message is provided by one selected from the group consisting of:
a network database, and
a mobile communication device database.

6. The coordinator as recited in claim 1 further comprising a message assigning unit coupled to said sender location unit and configured to assign said predefined SMS message to a contact addressee.

7. The coordinator as recited in claim 6 wherein said predefined SMS message is assigned to said contact addressee employing one selected from the group consisting of:
a manual assignment process; and
an automated assignment process.

8. The coordinator as recited in claim 6 wherein selection of said contact addressee for assignment is based on one selected from the group consisting of:
a contact location; and
an addressee group.

9. The coordinator as recited in claim 1 wherein automatically sending said predefined SMS message corresponds to said location changing from one serving cell to another serving cell of a cellular system.

10. The coordinator as recited in claim 1 wherein automatically sending said predefined SMS message corresponds to said location remaining in a same serving cell of a cellular system for a predetermined period of time.

11. A method of coordinating a location message, for use with a short message service (SMS), comprising:
determining a location of a mobile communication device; and
automatically sending a predefined SMS message based on said location of said mobile communication device.

12. The method as recited in claim 11 wherein said location is based on a Cell-ID in a cellular system.

13. The method as recited in claim 12 wherein said location is determined by a look-up table that maps said Cell-ID into a geographic region.

14. The method as recited in claim 11 wherein a portion of said predefined SMS message is amendable.

15. The method as recited in claim 11 wherein said predefined SMS message is provided by one selected from the group consisting of:
a network database, and
a mobile communication device database.

16. The method as recited in claim 11 further comprising assigning said predefined SMS message to a contact addressee.

17. The method as recited in claim 16 wherein said predefined SMS message is assigned to said contact addressee employing one selected from the group consisting of:
a manual assignment process; and
an automated assignment process.

18. The method as recited in claim 16 wherein selection of said contact addressee for assignment is based on one selected from the group consisting of:
a contact location; and
an addressee group.

19. The method as recited in claim 11 wherein automatically sending said predefined SMS message corresponds to said location changing from one serving cell to another serving cell of a cellular system.

20. The method as recited in claim 11 wherein automatically sending said predefined SMS message corresponds to said location remaining in a same serving cell of a cellular system for a predetermined period of time.

21. A cellular system, comprising:
a communications network employing a cellular grid and providing a short message service (SMS);
a mobile communication device coupled to said cellular grid; and
a location message coordinator coupled to said mobile communication device, including:
a sender location unit that determines a location of said mobile communication device;
a message assigning unit, coupled to said sender location unit, that assigns a predefined SMS message to a contact addressee; and
a message sending unit, coupled to said message assigning unit, that automatically sends said predefined SMS message to said contact addressee based on said location of said mobile communication device.

22. The system as recited in claim 21 wherein said location is based on a Cell-ID in a cellular system.

23. The system as recited in claim 22 wherein said location is determined by a look-up table that maps said Cell-ID into a geographic region.

24. The system as recited in claim 21 wherein a portion of said predefined SMS message is amendable.

25. The system as recited in claim 21 wherein said predefined SMS message is provided by one selected from the group consisting of:
a network database, and
a mobile communication device database.

26. The system as recited in claim 21 wherein said predefined SMS message is assigned to said contact addressee employing one selected from the group consisting of:
a manual assignment process; and
an automated assignment process.

27. The system as recited in claim 21 wherein selection of said contact addressee for assignment is based on one selected from the group consisting of:
a contact location; and
an addressee group.

28. The system as recited in claim 21 wherein automatically sending said predefined SMS message corresponds to said location changing from one serving cell to another serving cell of a cellular system.

29. The system as recited in claim 21 wherein automatically sending said predefined SMS message corresponds to said location remaining in a same serving cell of a cellular system for a predetermined period of time.
